(19) United States
(12) Patent Application Publication
(10) Pub. No.: US 2025/0202899 A1
(43) Pub. Date: Jun. 19, 2025

(54) PRIORITIZATION AND APPROVAL AUTOMATIONS FOR EFFECTIVE USER ACCESS RIGHTS MANAGEMENT

(71) Applicant: Visa International Service Association, San Francisco, CA (US)

(72) Inventors: Hanlin Chen, Danville, CA (US); Durga Prasad Balakrishnan, Cedar Park, TX (US); Aadithya Jerome Prabhakar Francis, Cedar Park, TX (US); Dominique Louis Fedronic, Belmont, CA (US)

(73) Assignee: Visa International Service Association, San Francisco, CA (US)

(21) Appl. No.: 18/544,527

(22) Filed: Dec. 19, 2023

(51) Int. Cl. H04L 9/40

(52) U.S. Cl. CPC H04L 63/101; H04L 63/102; H04L 63/1433

(57) ABSTRACT

Disclosed are systems and methods for effectively managing user access rights, including processing and revalidating user access requests. A computer-implemented method determines an entitlement risk score, a user risk score, and an overall risk score associated with a user access request based on criticality models and metadata. Based on the overall risk score, a criticality level is assigned to the user access request, and the computer-implemented method processes the user access request. The user access request is either automatically or manually processed based on the assigned criticality level. A plurality of user access requests requiring manual processing are processed based on an external input, and the plurality of user access requests are prioritized based on their respective assigned criticality levels and processing histories.

### TECHNICAL FIELD

The following disclosure relates generally to prioritization and processing automations for effectively managing user access rights, including user access requests and user access revalidating requests, based on a criticality level assigned to a user access request or a user access revalidating request.

### SUMMARY

In part, in one aspect, the present disclosure provides a system for managing a user access request, the system including an access criticality module to determine information associated with a user access request; an access criticality evaluation computation engine to determine a risk score associated with the user access request based on the determined information and to assign a criticality level to the user access request based on the determined risk score; an automation and prioritization integrator to determine, based on the assigned criticality level, automatic or manual processing of the user access request; and an access management module to automatically or manually process the user access request based on the determination of the automation and prioritization integrator.

In part, in one aspect, the present disclosure provides a computer-implemented method for managing a user access request, the computer-implemented method including determining, based on an entitlement criticality model and entitlement metadata, an entitlement risk score of a user access request, the entitlement risk score relates to a risk associated with an access type of the user access request; determining, based on a user criticality model and user metadata, a user risk score of the user access request, the user risk score relates to a risk associated with an identity of the user access request; determining an overall risk score of the user access request based on a combination of the entitlement risk score and the user risk score; assigning, based on the overall risk score, a criticality level to the user access request, the criticality level is one of a first criticality level or a second criticality level that is greater than the first criticality level; automatically processing, based on the first criticality level being assigned to the user access request, the user access request by an access management system; and processing, based on the second criticality level being assigned to the user access request, the user access request by an access management system based on an external input received by the access management system.

In part, in one aspect, the present disclosure provides a computer-implemented method for managing a plurality of user access requests, the computer-implemented method including determining, based on an entitlement criticality model and entitlement metadata, an entitlement risk score for each user access request of a plurality of user access requests, the entitlement risk score for each user access request relates to a risk associated with an access type of each user access request; determining, based on a user criticality model and user metadata, a user risk score for each user access request, the user risk score for each user access request relates to a risk associated with an identity of each user access request; determining an overall risk score for each user access request based on a combination of the entitlement risk score and the user risk score associated with each user access request; assigning, based on the overall risk score of each user access request, a criticality level to each user access request, the criticality level is one of a first criticality level or a second criticality level that is greater than the first criticality level; assigning each user access request to a first set of requests or a second set of requests, the first set of requests comprises each user access request that was assigned the first criticality level, and the second set of requests comprises each user access request that was assigned the second criticality level; automatically processing each user access request of the first set of requests by an access management system; and processing each user access request of the second set of requests by an access management system based on a plurality of external inputs received by the access management system.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a flow diagram of a user access rights management system, according to at least one aspect of the present disclosure.

FIG. 2 illustrates a method to calculate each of an entitlement risk score, a user risk score, and a dynamic risk score, according to at least one aspect of the present disclosure.

FIG. 3 illustrates a process flow diagram for determining an entitlement risk score, according to at least one aspect of the present disclosure.

FIG. 4 illustrates a method to manage a user access request, according to at least one aspect of the present disclosure.

FIG. 5 illustrates a method to manage a plurality of user access requests, according to at least one aspect of the present disclosure.

FIG. 6 is a block diagram of a computer apparatus with data processing subsystems or components, according to at least one aspect of the present disclosure.

FIG. 7 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

A “processing network” may include an electronic system used to accept, transmit, or process transactions made by devices. The processing network may transfer information among transacting parties (e.g., issuers, acquirers, merchants, device users, etc.).

As used herein, a “secure element” may include a secure computer memory in an electronic device capable of storing sensitive data or applications. A secure element may, but need not be, physically isolated from other memory in an electronic device. A secure element may comprise, or may be contained within, a hardware security module, a software security module, or other mechanism providing for secure and controlled access to the data stored within it. A secure element may further comprise a dedicated crypto-processor used for accessing its contents and executing secure operations.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “user” may include an individual. In some embodiments or aspects, a user may be associated with one or more personal accounts and/or mobile devices. The user may also be referred to as a cardholder, account holder, or consumer.

Almost all business entities, especially those having a large number of employees, also referred to herein as users, utilize a user access rights management system. The user access rights management system may differ from one business entity to another, however the general outcome is the same. That is, any such user access rights management system may manage each user's access rights for certain systems, services, or the like that are utilized by a business entity. For example, high-end executives may have significant user access rights which grant access to most, or all, systems, services, or the like, while users holding entry-level positions may have minimal user access rights for the same systems, services, or the like.

One of the difficulties of utilizing a user access rights management system is managing the large number of user access requests, or revalidating requests, which, in some instances, may result is over a million tasks to be completed by the user access rights management system at any given time. As a result, it is difficult for reviewers to provide diligent, well-informed decisions with regard to each user access request, or revalidating request. For example, due to a large number of tasks, a group of relatively few reviewers may “rubber stamp” the tasks without appropriate consideration of each contributing factor, which may lead to an increased risk of a mistake. Any such mistake may greatly affect the business entity, or pose a serious risk to the business entity's security. For example, if a high-end executive is not properly granted access to the necessary systems, services, or the like that are required for their position, there may be a considerable delay in completing work. Furthermore, if a user holding an entry-level position is mistakenly granted access to high-end systems, services, or the like, they may access critical information and pose a serious risk to the business entity's security. Thus, in situations where a large number of tasks, such as user access requests or user access revalidating requests, must be completed by the user access rights management system, it is important to establish quality automation and prioritization techniques. However, there currently exists a lack of a complete, exhaustive, and extensible approach for automating and prioritizing each task correctly. Accordingly, the present disclosure provides a solution that implements an automation and prioritization approach that accurately, and effectively, completes each task of the user access rights management system.

Additionally, risks may arise based on a user access rights management system only reviewing and processing user access rights during a mandatory access revalidation period. For example, a business entity may only revalidate user access rights once a year, once every six months, or the like. As a result, any such user that may change positions, or be relieved of their duties, between two mandatory access revalidation periods may possess incorrect user access rights until a following mandatory access revalidation period. This may greatly affect the business entity, or pose a serious risk to the business entity's security. For example, if a user is promoted to a high-end executive position, but their user access rights are not updated accordingly, there may be a considerable delay in completing work. Furthermore, if a user is relieved of their duties, but their user access rights are not updated, or removed, they may continue to access critical information beyond their tenure, which may pose a serious risk to the business entity's security. Thus, it is may be desirable to further incorporate continuous, or on-demand, user access revalidating requests into the solution disclosed herein.

Altogether, the solution disclosed herein provides a user access rights management system that combines an automation and prioritization approach with continuous, or on-demand, user access revalidating requests. The disclosed user access rights management system may be utilized by any business entity to accurately manage a large number of user access requests, or revalidating requests, despite having relatively few reviewers, and further despite changes in several contributing factors. In short, the solution disclosed herein may first utilize an access criticality module and an access criticality evaluation computation engine. The access criticality module may determine an entitlement risk score, a user risk score, and a dynamic risk score, which may be referred to herein as an overall risk score and which is a combination of the entitlement risk score and the user risk score, of at least one user access request, or revalidating request. The access criticality evaluation computation engine may combine each of the entitlement risk score, the user risk score, and the dynamic risk score. The solution may further assign a criticality level to the at least one user access request, or revalidating request, based on the combined risk scores, and send information relating to the criticality level to at least one repository. An automation and prioritization integrator may then determine, based on the assigned criticality level, if the at least one user access request, or revalidating request, is to be automatically or manually processed (e.g., automatically or manually granted or denied). Finally, upon processing, user access may be granted or denied to a user associated with the at least one user access request, or revalidating request. Additional details and features relating to the solution disclosed herein are described in greater detail below.

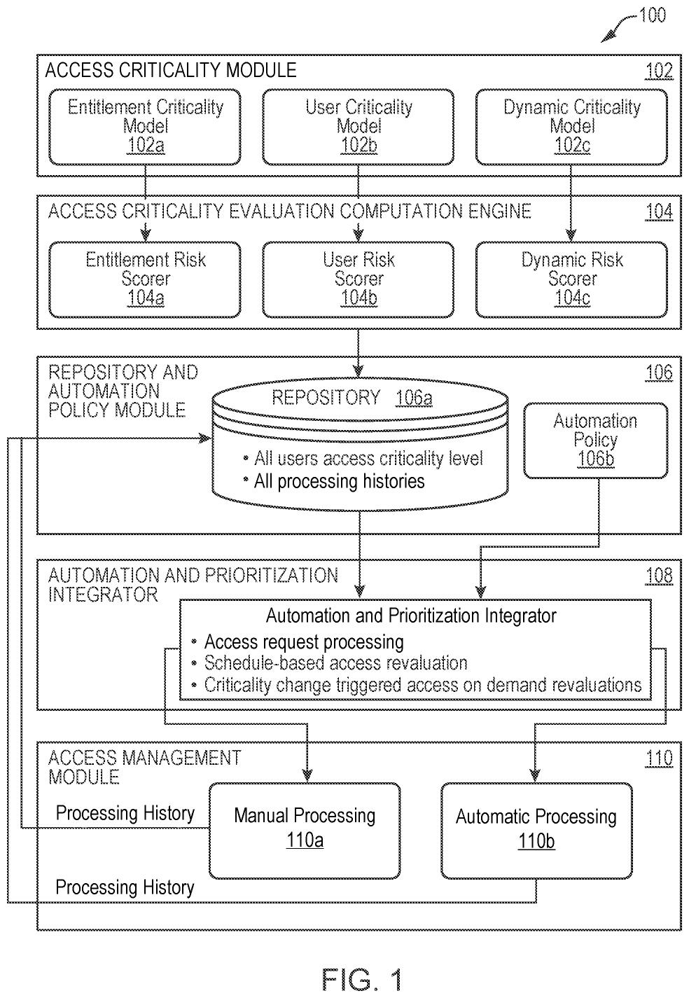

Now, with respect to the figures, FIG. 1 illustrates a flow diagram of a user access rights management system 100, according to at least one aspect of the present disclosure. The user access rights management system 100 may include an access criticality module 102, an access criticality evaluation computation engine 104, a repository and automation policy module 106, an automation and prioritization integrator 108, and an access management module 110. Altogether, the user access rights management system 100 provides a solution, which combines an automation and prioritization approach with continuous, or on-demand, user access revalidating requests to allow a business entity, such as a payment network (e.g., Visa, Inc.), to accurately manage user access rights.

In at least one aspect, the user access rights management system 100 begins with the access criticality module 102, which further includes an entitlement criticality model 102a, a user criticality model 102b, and a dynamic criticality model 102c.

The entitlement criticality model 102a may determine the nature of a user access request, or revalidation, and the environment for which access is requested. Altogether, the nature of access and the environment for which access is requested may affect an associated entitlement risk score, and thus a criticality level, that will be determined at a later point. A first non-limiting example illustrates that read-only access to a document may be less risky than full access to a document, which may include the ability to edit the document. A second non-limiting example illustrates that access to low-risk application data may be less risky than access to high-risk application data. A third non-limiting example illustrates that access to a low-risk network zone may be less risky than access to a high-risk network zone. A fourth non-limiting example illustrates that access to different data classifications corresponds to different associated risk scores, and thus different criticality levels. For example, access to highly classified data may correspond to a higher associated risk score, and thus a higher criticality level, than access to non-classified data.

The user criticality model 102b may determine the nature of the user's identity, which may affect an associated user risk score, and thus the criticality level, that will be determined at a later point. A first non-limiting example illustrates that granting access to a temporary, or contracted, user is more risky than granting access to a full-time user. A second non-limiting example illustrates that granting executive-level access is more risky than granting entry-level access. For example, if executive-level access is accidentally granted, significant damages and losses may occur due to a security breach, while, on the other hand, accidentally granting entry-level access will likely lead to minimal damages and losses, if any. A third non-limiting example illustrates that granting access to a user changing positions, such as transferring from one department to another, or receiving a promotion/demotion, is more risky than granting access, or revalidating access, to a user who is not changing position.

The dynamic criticality model 102c may determine an associated risk based on a combination of the data gathered by the entitlement criticality model 102a and the user criticality model 102b. A first non-limiting example illustrates that a user access request, or revalidation, that violates segregation of duty is always very risky. A second non-limiting example illustrates that granting temporary, time-bound, or just-in-time access is always less risky than granting full access. A third non-limiting example illustrates that a team outlier is considered suspicious and risky. For example, if only one user, or a few users, of a team is requesting access, or revalidation, the request may be considered suspicious and risky. A fourth non-limiting example illustrates that granting access to a user who has not been reviewed previously is more risky than granting access to a user who has been reviewed at least once in the past. A fifth non-limiting example illustrates that granting access to a new user is more risky than granting access, or revalidation, to a pre-existing user. A sixth non-limiting example illustrates than granting access to a system which is used by a large population is more risk than granting access to a system which is used by a small population. For example, a user who has edit access to a document viewable by the public is more risky than a user who has edit access to a document viewable only by a select few.

Altogether, the entitlement criticality model 102a, the user criticality model 102b, and the dynamic criticality model 102c may determine the risks associated with a user access request, or a user access revalidating request. In at least one aspect, the determined associated risks from each of the entitlement criticality model 102a, the user criticality model 102b, and the dynamic criticality model 102c may be sent to an entitlement risk scorer 104a, a user risk scorer 104b, and a dynamic risk scorer 104c, respectively, which are included within the access criticality evaluation computation engine 104.

The entitlement risk scorer 104a may be responsible for computing an entitlement risk score based on the data gathered from the entitlement criticality model 102a, as well as entitlement metadata. In at least one aspect, the entitlement metadata may include information, such as a risk score value, corresponding to each contributing factor of the entitlement data. The user risk scorer 104b may be responsible for computing a user risk score based on the data gathered from the user criticality model 102b, as well as user metadata. In at least one aspect, the user metadata may include information, such as a risk score value, corresponding to each contributing factor of the user data. The dynamic risk scorer 104c may be responsible for computing a dynamic risk score based on the data gathered from the dynamic criticality model 102c, as well as a combination of the entitlement metadata and the user metadata.

In at least one aspect, after the access criticality evaluation computation engine 104 computes an entitlement risk score, a user risk score, and a dynamic risk score by way of the entitlement risk scorer 104a, the user risk scorer 104b, and the dynamic risk scorer 104c, respectively, the user access rights management system 100 may assign a criticality level to the user access request, or revalidating request. In at least one aspect, the criticality level may be at least one of a first criticality level or a second criticality level that is greater than the first criticality level. In another aspect, the criticality level may be at least one of a first criticality level, such as a “low” criticality level, a second criticality level, such as a “medium” criticality level, that is greater than the first criticality level, a third criticality level, such as a “high” criticality level, that is greater than the second criticality level, or a fourth criticality level, such as a “critical” criticality level, that is greater than the third criticality level. In yet another aspect, the criticality level may be any one of an infinite number of criticality levels, where each criticality level may correspond to a numerical value. The example number of criticality levels, as disclosed above, is not so limiting. In all aspects, the criticality level is assigned based on at least a combination of the entitlement risk score, the user risk score, and the dynamic risk score as computed by the access criticality evaluation computation engine 104.

After assigning a criticality level to the user access request, or revalidating request, the user access rights management system 100 stores the assigned criticality level in at least one repository 106a, which is included in the repository and automation policy module 106. The at least one repository 106a may further store additional users' user access request, or revalidating request, criticality levels. The at least one repository 106a may further store a processing history, including previously-granted, or previously-denied, user access requests, or revalidating requests, as well as the previously-granted, or previously-denied, user access requests', or revalidating requests', timestamps, for all users of any such business entity.

The repository and automation policy module 106 further includes automation policy 106b, which may define how automation and prioritization decisions should be made based on the assigned criticality level, as well as a processing history, associated with a user corresponding to a user access request, or revalidating request. A series of non-limiting examples is provided below with regard to at least one aspect where the user access rights management system 100 includes two criticality levels, such as first and a second criticality levels as disclosed above. Additionally, a series of non-limiting examples is provided below with regard to another aspect where the user access rights management system 100 includes four criticality levels, such as “low,” “medium,” “high,” and “critical” criticality levels as detailed above.

A first non-limiting example of an automation policy 106b including two criticality levels illustrates that a user access request, or revalidating request, that is assigned the second criticality level must always require manual review and processing. A second non-limiting example illustrates that a user access request, or revalidating request, that is assigned the first criticality level may be automatically reviewed and processed. However, this may further depend on each of, or a combination of, the criticality level and the processing history of the user access request, or revalidating request. For example, a user access request, or revalidating request, may not be automatically processed if it has not been manually reviewed and processed at least once in the past. A third non-limiting example illustrates that a user access request, or revalidating request, that is assigned the first criticality level may require frequent manual review and processing. The frequency of required manual review and processing may be determined by each of, or a combination of, the criticality level and the processing history of the user access request, or revalidating request.

A first non-limiting example of an automation policy 106b including four criticality levels illustrates that a user access request, or revalidating request, that is assigned the “high” or “critical” criticality levels must always require manual review and processing. A second non-limiting example illustrates that a user access request, or revalidating request, that is assigned the “low” or “medium” criticality levels may be automatically reviewed and processed. However, this may further depend on each of, or a combination of, the criticality level and the processing history of the user access request, or revalidating request. For example, a user access request, or revalidating request, may not be automatically processed if it has not been manually reviewed and processed at least once in the past. A third non-limiting example illustrates that a user access request, or revalidating request, that is assigned the “low” or “medium” criticality levels may require frequent manual review and processing. The frequency of required manual review and processing may be determined by each of, or a combination of, the criticality level and the processing history of the user access request, or revalidating request.

An additional non-limiting example illustrates that the automation policy 106b may balance the total number of manual and automatic processing for a plurality of user access requests, or revalidating requests, based on a number of available resources, such as a number of reviewers, and a criticality level associated with each user access request, or revalidating request, of the plurality of user access requests, or revalidating requests. That is, to ensure accurate and timely processing, the automation policy 106b may provide a balance between manual and automatic processing. For example, during a period that includes an overwhelming amount of user access requests, or revalidating requests, the automation policy 106b may instruct the user access rights management system 100 to automatically process a user access request, or revalidating request, that has been assigned a relatively low criticality level, even if it would typically require manual review and processing, such as when the user access request, or revalidating request, has not been manually reviewed and processed in the past.

Altogether, the repository and automation policy module 106 acts as an important part of the user access rights management system 100 by assigning a criticality level to a user access request, or revalidating request, storing the assigned criticality level in at least one repository 106a, and providing an automation policy 106b that defines how automation and prioritization decisions should be made in the user access rights management system 100. In at least one aspect, each of the assigned criticality level and a processing history associated with the user access request, or revalidating request, as well as the automation policy 106b, may be provided to the automation and prioritization integrator 108.

In at least one aspect, the automation and prioritization integrator 108 may determine, based on information received from the repository and automation policy module 106, whether a user access request, or revalidating request, should be manually processed or automatically processed. Furthermore, for a user access request, or revalidating request, that is determined to require manual review and processing, the automation and prioritization integrator 108 may generate prioritization based on each of, or a combination of, a criticality level and a processing history corresponding to the user access request, or revalidating request. For example, in at least one aspect, a user access request, or revalidating request, having a high criticality level may be prioritized over another user access request, or revalidating request, having a low criticality level. In another aspect, a user access request, or revalidating request, having no processing history may be prioritized over another user access request, or revalidating request, that has been processed at least once previously. In yet another aspect, a user access request, or revalidating request, having a high criticality level and no processing history may be prioritized over another user access request, or revalidating request, having a low criticality level and which has been processed at least once previously. It should be noted that other combinations of a criticality level and a processing history are possible, though not all possible combinations are disclosed herein. As such, the examples disclosed above are not so limiting.

In at least one aspect, the automation and prioritization integrator 108 may further generate a prioritization list for display on a user interface as used by a reviewer. Even further, the automation and prioritization integrator 108 may generate a visual indicator for each task, which corresponds to a level of priority as determined by the automation and prioritization integrator 108, for display on the user interface as used by a reviewer. By generating each of, or both of, the prioritization list and the visual indicator for each task, a reviewer may accurately review and process tasks requiring manual review and processing in an effective manner based on a determined priority.

It at least one aspect, the automation and prioritization integrator 108 may further generate on-demand user access revalidation, or re-processing, based on a determination that the assigned criticality level of a user access request, or revalidating request, is different than a previously-assigned criticality level of the user access request, or revalidating request, associated with a previous processing of the user access request, or revalidating request. In at least one aspect, the automation and prioritization integrator 108 may generate the on-demand access revalidation, or re-processing, based on the change in the criticality level exceeding a predetermined criteria. In one non-limiting example, such a predetermined criteria may include a change from a criticality level that allows automatic processing to a criticality level that requires manual review and processing.

It at least one aspect, the automation and prioritization integrator 108 may further initiate schedule-based user access revalidation, or re-processing. Since the automation and prioritization integrator 108 generates on-demand user access revalidation, or re-processing, the schedule-based user access revalidation, or re-processing, may not be as frequent. Nonetheless, the schedule-based user access revalidation, or re-processing, may be once a year, once every six months, once every three months, or the like.

Based on the determination by the automation and prioritization integrator 108 due to the assigned criticality level and the processing history associated with a user access request, or revalidating request, the access management module 110 may initiate prioritized manual processing 110a or automatic processing 110b. In at least one aspect, manual processing 110a may include manual approval (e.g., granting access) or disapproval (e.g., denying access). In at least one aspect, automatic processing 110b may include automatic approval (e.g., granting access) or disapproval (e.g., denying access). As a result, the user access request, or revalidating request, may be completed and access may be granted or denied to a user associated with the user access request, or revalidating request. Additionally, the prioritized manual processing 110a or automatic processing 110b will be provided to the at least one repository 106a such that a processing history associated with the user access request, or revalidating request, may be updated in the repository and automation policy module 106.

In at least one aspect, the user access rights management system 100 may further include continuous, on-demand, or schedule-based updates to determine an updated entitlement risk score, an updated user risk score, and an updated dynamic risk score. Altogether, the updated entitlement risk score, the updated user risk score, and the updated dynamic risk score may be combined to assign an updated criticality level to a user access request, or revalidating request. As a result, the user access rights management system 100 may process the user access request, or revalidating request, either manually or automatically based on a change between the updated criticality level and a previously-assigned criticality level associated with the user access request, or revalidating request. By utilizing continuous, on-demand, or schedule-based updates, the user access rights management system 100 may allow business entities to accurately manage a large number of user access requests, or revalidating requests, despite having relatively few reviewers, and further despite changes in several contributing factors.

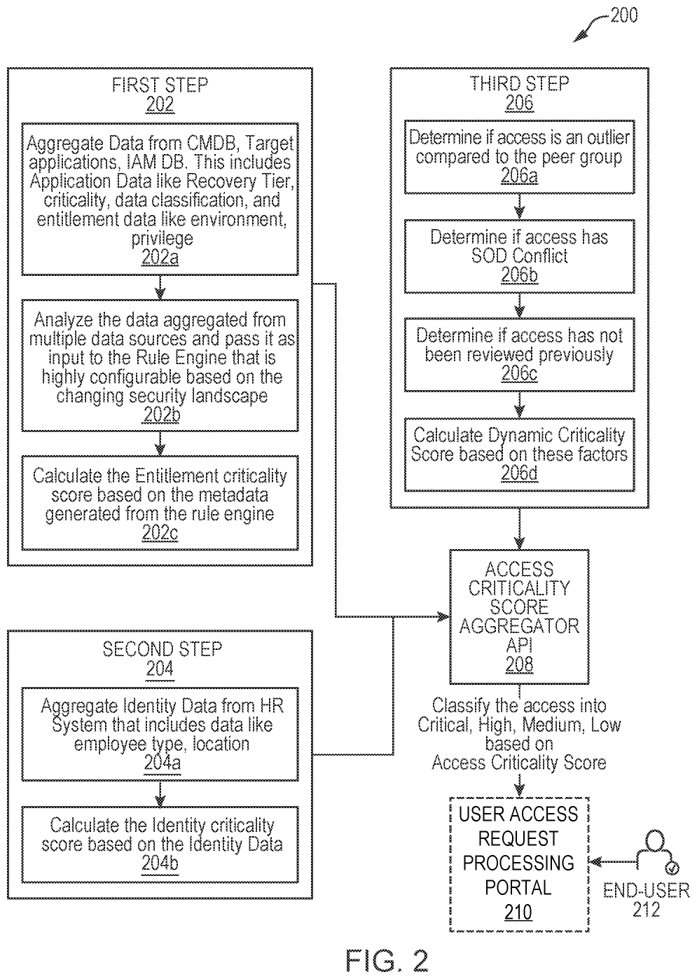

FIG. 2 illustrates a method 200 to calculate each of an entitlement risk score, a user risk score, and a dynamic risk score, according to at least one aspect of the present disclosure. In at least one aspect, the method 200 may include a first step 202 to calculate an entitlement risk score of a user access request, or revalidating request, as performed by an entitlement criticality model, such as the entitlement criticality model 102a of FIG. 1, a second step 204 to calculate a user risk score of the user access request, or revalidating request, as performed by a user criticality model, such as the user criticality model 102b of FIG. 1, and a third step 206 to calculate a dynamic risk score of the user access request, or revalidating request, as performed by a dynamic criticality model, such as the dynamic criticality model 102c of FIG. 1. As a result, it should be noted that a combination of the first step 202, the second step 204, and the third step 206 form the basis of an access criticality module, such as the access criticality module 102 of FIG. 1. Each of the first step 202, the second step 204, and the third step 206 is described in greater detail below.

The first step 202 may aggregate 202a data from a configuration management database (CMDB), an identity and access management database (IAM DB), and various target applications. A target application may include at least one of an application, system, or service for which a user access request is requesting permission to access. The aggregated data may include application data such as a related recovery tier, a data criticality level, a data classification level, a network, or the like associated with a user access request, or revalidating request. In other words, the aggregated data may include information relating to the importance of the application data. Additionally, the aggregated data may include entitlement data relating to an environment, privilege, or the like associated with a user access request, or revalidation. The first step 202 may further analyze 202b the aggregated data and pass the aggregated data to an input of a rule engine. The rule engine may be highly configurable based on the changing security landscape, and may further provide metadata relating to the aggregated data. Finally, the first step 202 may further calculate 202c an entitlement risk score based on the provided metadata generated from the rule engine.

The second step 204 may aggregate 204a data from a human resources system, which may include data relating to a user type, a user hierarchy level, a user location, a user length of service, or the like of a user associated with a user access request, or revalidation. For example, a user type may relate to whether a user is a temporary, contracted, or full-time user, or the like. A user hierarchy level may relate to whether a user holds an entry-level position, an executive-level position, or the like. A user location may relate to whether a user is nearby relevant locations, or if the user is in a different city, state, country, or the like, which may be the case for a fraudulent user attempting to cyber-attack a business entity's systems, services, or the like. A user length of service may relate to whether a user is a long-term user, a trustworthy user, a new hire, or the like. Finally, the second step 204 may further calculate 204b a user risk score based on each of, or a combination of, the aforementioned contributing factors.

The third step 206 may determine 206a if a user access request, or revalidating request, is an outlier compared to a peer group. For example, as disclosed above, if only one user, or a few users, of a team is requesting access, or revalidation, the request may be considered suspicious and risky. The third step 206 may further determine 206b if a user access request, or revalidating request, violates segregation of duty. For example, if a user access request, or revalidating request, is requesting access to all systems, services, or the like that are required to complete a task unassisted, the request may be considered suspicious and risky. The third step 206 may further determine 206c if a user access request, or revalidating request, has been processed at least once previously. As disclosed above, any user that has not been processed at least once previously poses a greater risk as compared to users who have been processed at least once previously. Finally, the third step 206 may further calculate 206d a dynamic risk score based on each of, or a combination of, the aforementioned contributing factors.

In at least one aspect, the method 200 may further aggregate each of the entitlement risk score, the user risk score, and the dynamic risk score at an access criticality score aggregator application programming interface 208, which may perform substantially the same function as an access criticality evaluation computation engine, such as the access criticality evaluation computation engine 104 of FIG. 1. That is, the access criticality score aggregator application programming interface 208 may combine each of the calculated entitlement risk score, user risk score, and dynamic risk score, and assign a criticality level to the user access request, or revalidating request, as a result. As disclosed above, in at least one aspect, the criticality level may be at least one of a first criticality level or a second criticality level that is greater than the first criticality level. In another aspect, the criticality level may be at least one of a first criticality level, such as a “low” criticality level, a second criticality level, such as a “medium” criticality level, that is greater than the first criticality level, a third criticality level, such as a “high” criticality level, that is greater than the second criticality level, or a fourth criticality level, such as a “critical” criticality level, that is greater than the third criticality level. In yet another aspect, the criticality level may be any one of an infinite number of criticality levels, where each criticality level may correspond to a numerical value. The example number of criticality levels, as disclosed above, is not so limiting. In all aspects, the criticality level is assigned based on a combination of the entitlement risk score, the user risk score, and the dynamic risk score as computed by each of the first step 202, the second step 204, and the third step 206, respectively.

In at least one aspect, the method 200 may further process a user access request, or revalidating request, of an end-user 212 at a user access request processing portal 210, which may perform substantially the same function as an access management module, such as the access management module 110 of FIG. 1. That is, the user access request processing portal 210 may process, either manually or automatically, the user access request, or revalidating request. Similar to the access management module 110 of FIG. 1, the user access request processing portal 210 may utilize each of, or a combination of, a criticality level and a processing history of a user access request, or revalidating request, to determine if the user access request, or revalidating request, may be manually or automatically processed.

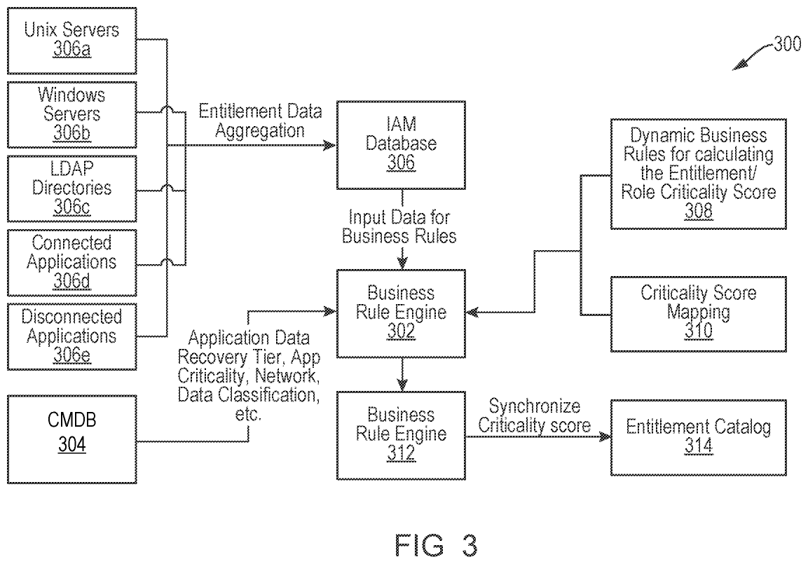

FIG. 3 illustrates a process flow diagram 300 to determine an entitlement risk score, according to at least one aspect of the present disclosure. In at least one aspect, the determined entitlement risk score of FIG. 3 may be substantially the same as the calculated entitlement risk score of each of FIGS. 1 and 2. In at least one aspect, the process flow diagram 300 may include a business rule engine 302, which may gather data from each of a configuration management database (CMDB) 304 and an identity and access management (IAM) database 306, and which may receive dynamic business rules 308, which may be necessary calculate the entitlement risk score, and a criticality score mapping 310, and which may further provide computational results to a rule engine database 312.

In at least one aspect, the configuration management database 304 may aggregate application data such as a related recovery tier, a data criticality level, a data classification level, a network, or the like associated with a user access request, or revalidating request. After aggregating the application data, the configuration management database 304 may provide the application data to an input of the business rule engine 302. The identity and access management database 306 may aggregate entitlement data from each of at least one UNIX server 306a, at least one Windows server 306b, at least one lightweight directory access protocol (LDAP) 306c, at least one connected application 306d, and/or at least one disconnected application 306e. After aggregating the entitlement data, the identity and access management database 306 may provide the entitlement data to an input of the business rule engine 302.

In at least one aspect, the dynamic business rules 308 may include rules, or instructions, for use in a computation engine such as the business rule engine 302. In at least one aspect, the criticality score mapping 310 may map computational results of the business rule engine 302 to assist the determination of an entitlement risk score based on a number of contributing factors. Furthermore, in at least one aspect, the computational results of the business rule engine 302 may be sent to the rule engine database 312 for storage, which may further synchronize the entitlement risk score with the entitlement catalog 314.

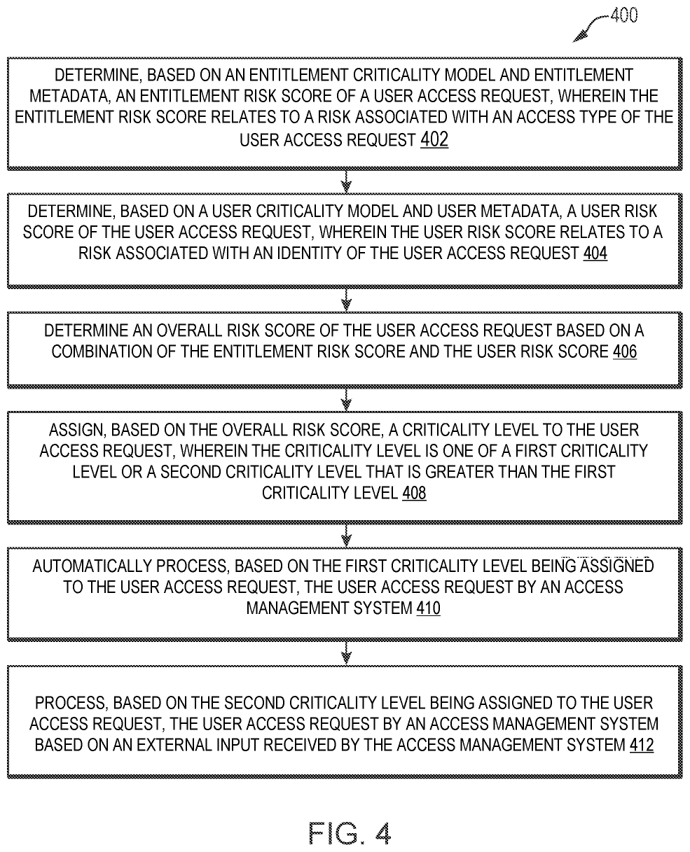

FIG. 4 illustrates a method 400 to manage a user access request, according to at least one aspect of the present disclosure. The method 400 shown in FIG. 4 will now be described together with the user access rights management system 100 shown in FIG. 1. Accordingly, with reference now to FIGS. 1 and 4, in at least one aspect, according to the method 400, the entitlement risk scorer 104a determines 402, based on an entitlement criticality model 102a and entitlement metadata, an entitlement risk score of a user access request, wherein the entitlement risk score relates to a risk associated with an access type of the user access request. The user risk scorer 104b determines 404, based on a user criticality model 102b and user metadata, a user risk score of the user access request, wherein the user risk score relates to a risk associated with an identity of the user access request. The dynamic risk scorer 104c determines 406, a dynamic risk score of the user access request based on a dynamic criticality model 102c and a combination of the entitlement risk score and the user risk score. In at least one aspect, after each of the aforementioned determinations, the method 400 further assigns 408, by the access criticality evaluation computation engine 104 and based on the dynamic risk score, a criticality level to the user access request, wherein the criticality level is one of a first criticality level or a second criticality level that is greater than the first criticality level. In at least one aspect, the method 400 further automatically processes 410, by the access management module 110 and based on the first criticality level being assigned to the user access request, the user access request, or processes 412, by the access management module 110 and based on the second criticality level being assigned to the user access request, the user access request based on an external input received by the user access rights management system 100. Altogether, each of 402, 404, 406, 408, 410 and 412 provide a method 400 to accurately, and effectively, manage a user access request. As would be appreciated by one having ordinary skill in the art, the method 400 may be carried out by any suitable computer apparatus, computer system, or the like.

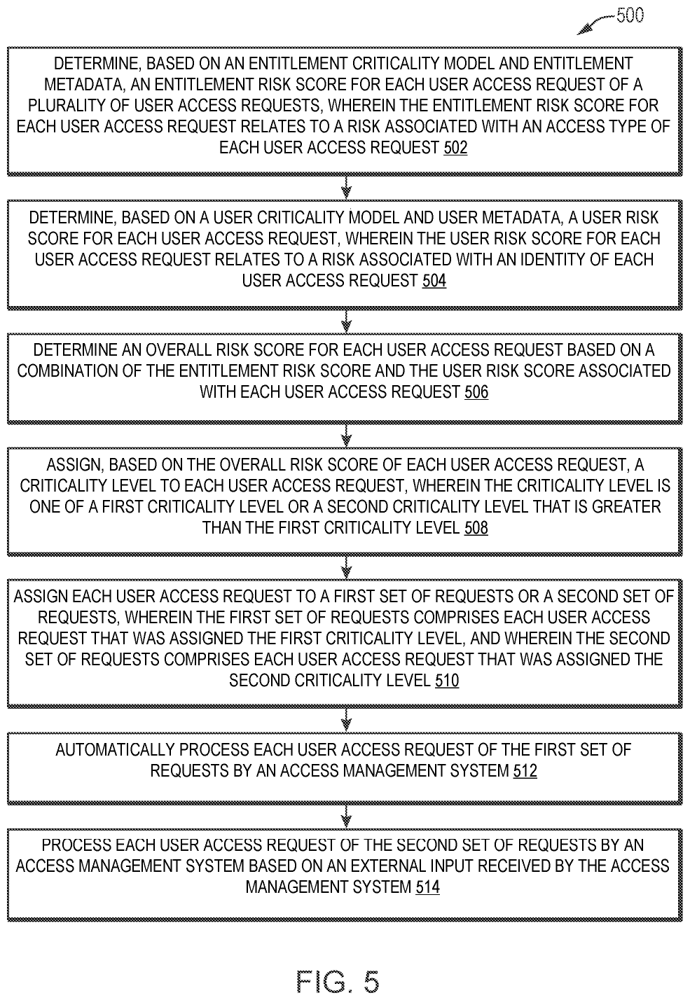

FIG. 5 illustrates a method 500 to manage a plurality of user access requests, according to at least one aspect of the present disclosure. The method 500 shown in FIG. 5 will now be described together with the user access rights management system 100 shown in FIG. 1. Accordingly, with reference now to FIGS. 1 and 5, in at least one aspect, according to the method 500, the entitlement risk scorer 104a determines 502, based on an entitlement criticality model 102a and entitlement metadata, an entitlement risk score for each user access request of a plurality of user access requests, wherein the entitlement risk score for each user access request relates to a risk associated with an access type of each user access request. The user risk scorer 104b determines 504, based on a user criticality model 102b and user metadata, a user risk score for each user access request, wherein the user risk score for each user access request relates to a risk associated with an identity of each user access request. The dynamic risk scorer 104c determines 506, a dynamic risk score for each user access request based on a dynamic criticality model 102c and a combination of the entitlement risk score and the user risk score associated with each user access request. In at least one aspect, after each of the aforementioned determinations, the method 500 further assigns 508, by the access criticality evaluation computation engine 104 and based on the dynamic risk score of each user access request, a criticality level to each user access request, wherein the criticality level is one of a first criticality level or a second criticality level that is greater than the first criticality level.

In at least one aspect, the method 500 further assigns 510, by the automation and prioritization integrator 108 and based on the automation policy 106b, each user access request to a first set of requests or a second set of requests, wherein the first set of requests comprises each user access request that was assigned the first criticality level, and wherein the second set of requests comprises each user access request that was assigned the second criticality level. In at least one aspect, the method 500 further automatically processes 512, by the access management module 110, each user access request of the first set of requests. In at least one aspect, the method 500 further processes 514, by the access management module 110, each user access request of the second set of requests based on an external input received by the user access rights management system 100. Altogether, each of 502, 504, 506, 508, 510, 512 and 514 provide a method 500 to accurately, and effectively, manage a plurality of user access requests. As would be appreciated by one having ordinary skill in the art, the method 500 may be carried out by any suitable computer apparatus, computer system, or the like.

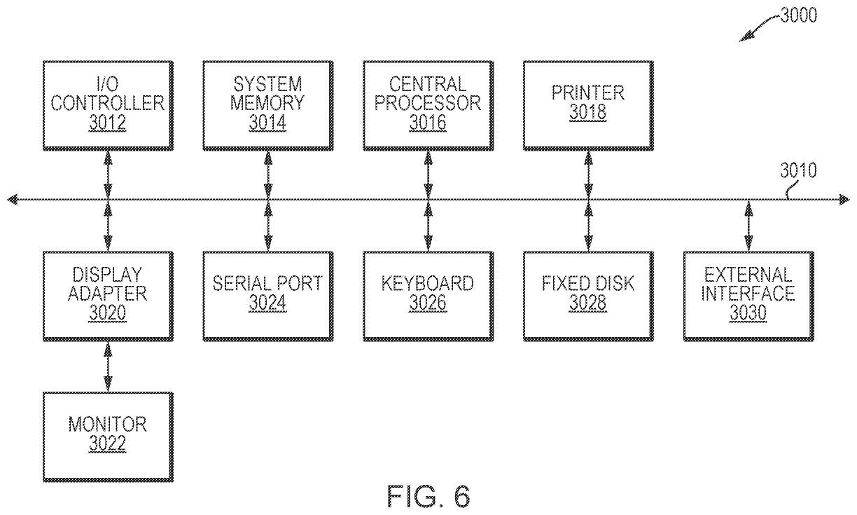

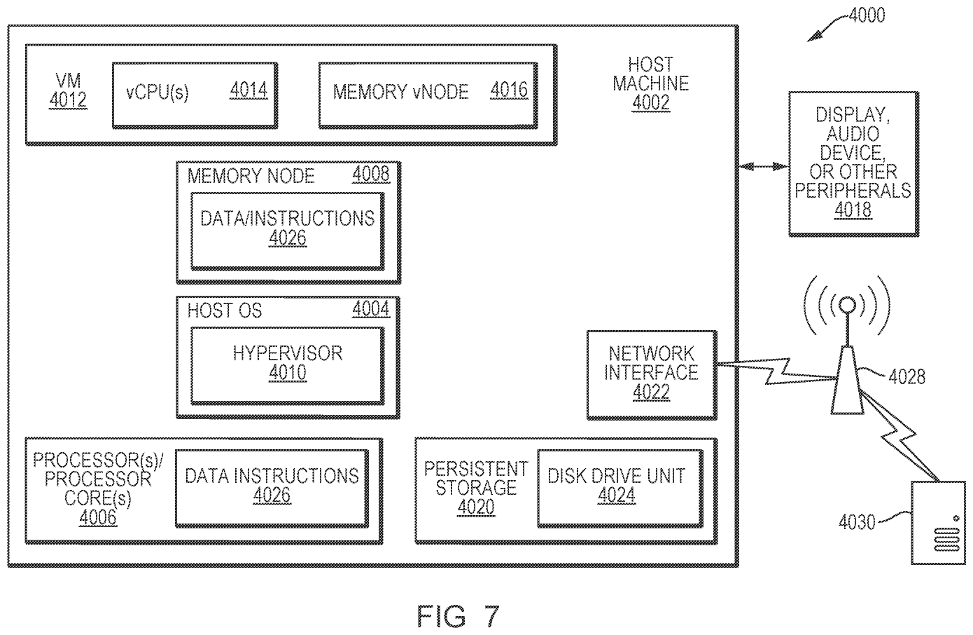

The aforementioned prioritization and processing automations for effectively managing user access rights, including user access request processing and user access revalidations, based on a determined criticality level may include, or make use of, a number of computer apparatuses, computer systems, or the like. In other words, in order to utilize the systems and methods disclosed herein, at least one of a computer apparatus, computer system, or the like may be implemented. Each of these computer apparatuses, computer systems, or the like are described in greater detail below with respect to the computer apparatus 3000 shown in FIG. 6 and computer system 4000 shown in FIG. 7, which provides a connection between the solution disclosed herein and how such a solution may be implemented within a business entity, such as a payment network, a processing network, a payment processing network, or the like.

FIG. 6 is a block diagram of a computer apparatus 3000 with data processing subsystems or components, according to at least one aspect of the present disclosure. The subsystems shown in FIG. 6 are interconnected via a system bus 3010. Additional subsystems such as a printer 3018, keyboard 3026, fixed disk 3028 (or other memory comprising computer-readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer-readable medium.

FIG. 7 is a diagrammatic representation of an example computer system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the computer system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the apparatus and method according to various aspects of the present disclosure are provided below in the following numbered clauses. An aspect of the apparatus or method may include any one or more than one, and any combination of, the numbered clauses described below.

Clause 1: A system for managing a user access request, the system comprising: an access criticality module to determine information associated with a user access request; an access criticality evaluation computation engine to determine a risk score associated with the user access request based on the determined information to assign a criticality level to the user access request based on the determined risk score; an automation and prioritization integrator is to determine, based on the assigned criticality level, automatic or manual processing of the user access request; and an access management module to automatically or manually process the user access request based on a determination of the automation and prioritization integrator.

Clause 2: The system according to Clause 1, wherein the access criticality module further comprises: an entitlement criticality model to determine information associated with an access type of the user access request; a user criticality model to determine information associated with an identity of the user access request; and a dynamic criticality model to determine information associated with a combination of the access type and the identity of the user access request.

Clause 3: The system according to either of Clauses 1 or 2, wherein the access criticality evaluation computation engine further comprises: an entitlement risk scorer to determine a risk score associated with an access type of the user access request; a user risk scorer to determine a risk score associated with an identity of the user access request; and a dynamic risk scorer to determine a risk score associated with a combination of the access type and the identity of the user access request.

Clause 4: The system according to any of Clauses 1-3, further comprising a repository and automation policy module comprising a repository and an automation policy.

Clause 5: The system according to any of Clauses 1-4, wherein the repository stores a processing history for the user access request, and wherein the automation policy defines how the determination of the automation and prioritization integrator is to be made.

Clause 6: The system according to any of Clauses 1-5, wherein the access management module is configured to generate a prioritization for the user access request based on the assigned criticality level and based on a determination that the user access request is to be manually processed.

Clause 7: The system according to any of Clauses 1-6, wherein the generated prioritization comprises a visual indicator visible to a user access request reviewer, and wherein the visual indicator corresponds to the assigned criticality level.

Clause 8: A computer-implemented method for managing a user access request, the computer-implemented method comprising: determining, based on an entitlement criticality model and entitlement metadata, an entitlement risk score of a user access request, wherein the entitlement risk score relates to a risk associated with an access type of the user access request; determining, based on a user criticality model and user metadata, a user risk score of the user access request, wherein the user risk score relates to a risk associated with an identity of the user access request; determining an overall risk score of the user access request based on a combination of the entitlement risk score and the user risk score; assigning, based on the overall risk score, a criticality level to the user access request, wherein the criticality level is one of a first criticality level or a second criticality level that is greater than the first criticality level; automatically processing, based on the first criticality level being assigned to the user access request, the user access request by an access management system; and processing, based on the second criticality level being assigned to the user access request, the user access request by an access management system based on an external input received by the access management system.

Clause 9: The computer-implemented method according to Clause 8, wherein the determining the entitlement risk score comprises: collecting data from at least one of a configuration management database, an identity and access management database, or a target application, wherein the data comprises at least one of entitlement data or application data; sending the data to a rule engine to generate the entitlement metadata; and calculating the entitlement risk score based on the entitlement metadata.

Clause 10: The computer-implemented method according to either of Clauses 8 or 9, wherein the determining the user risk score comprises: collecting data from a human resources system, wherein the data comprises at least one of a user type, a user hierarchy level, a user location, or a user length of service of a user associated with the user access request; and calculating the user risk score based on the data.

Clause 11: The computer-implemented method according to any of Clauses 8-10, wherein determining the overall risk score further comprises: determining that the user access request is an outlier compared to a plurality of user access requests associated with a plurality of users of a peer group; determining that the user access request violates segregation of duty; determining that the user access request has been previously processed by an external input received by the access management system; and calculating the overall risk score based on a combination of each determination.

Clause 12: The computer-implemented method according to any of Clauses 8-11, further comprising: determining an updated entitlement risk score of the user access request; determining an updated user risk score of the user access request; determining an updated overall risk score of the user access request based on a combination of the updated entitlement risk score and the updated user risk score; assigning, based on the updated overall risk score, an updated criticality level to the user access request, wherein the updated criticality level is one of the first criticality level or the second criticality level; generating a user access re-processing request based on the updated criticality level being different than the criticality level; and maintaining user access based on the updated criticality level being identical to the criticality level.

Clause 13: The computer-implemented method according to any of Clauses 8-12, further comprising: automatically processing, based on the updated criticality level being the first criticality level and the criticality level being the second criticality level, the user access re-processing request by the access management system; and processing, based on the updated criticality level being the second criticality level and the criticality level being the first criticality level, the user access re-processing request by the access management system based on an external input received by the access management system.

Clause 14: The computer-implemented method according to any of Clauses 8-13, further comprising storing the user access request in a processing history repository based on the user access request being processed.

Clause 15: A computer-implemented method for managing a plurality of user access requests, the computer-implemented method comprising: determining, based on an entitlement criticality model and entitlement metadata, an entitlement risk score for each user access request of a plurality of user access requests, wherein the entitlement risk score for each user access request relates to a risk associated with an access type of each user access request; determining, based on a user criticality model and user metadata, a user risk score for each user access request, wherein the user risk score for each user access request relates to a risk associated with an identity of each user access request; determining an overall risk score for each user access request based on a combination of the entitlement risk score and the user risk score associated with each user access request; assigning, based on the overall risk score of each user access request, a criticality level to each user access request, wherein the criticality level is one of a first criticality level or a second criticality level that is greater than the first criticality level; assigning each user access request to a first set of requests or a second set of requests, wherein the first set of requests comprises each user access request that was assigned the first criticality level, and wherein the second set of requests comprises each user access request that was assigned the second criticality level; automatically processing each user access request of the first set of requests by an access management system; and processing each user access request of the second set of requests by an access management system based on a plurality of external inputs received by the access management system.

Clause 16: The computer-implemented method according to Clause 15, wherein the determining the entitlement risk score for each user access request comprises: collecting data from at least one of a configuration management database, an identity and access management database, or a target application, wherein the data comprises at least one of entitlement data or application data; sending the data to a rule engine, wherein the rule engine generates the entitlement metadata; and calculating the entitlement risk score based on the entitlement metadata.

Clause 17: The computer-implemented method according to either of Clauses 15 or 16, wherein determining the user risk score for each user access request comprises: collecting data from a human resources system, wherein the data comprises at least one of a user type, a user hierarchy level, a user location, or a user length of service of a user associated with each user access request; and calculating the user risk score based on the data.

Clause 18: The computer-implemented method according to any of Clauses 15-17, wherein determining the overall risk score for each user access request further comprises: determining if each user access request is an outlier compared to a plurality of user access requests associated with a plurality of users of a peer group; determining if each user access request violates segregation of duty; determining if each user access request has been previously processed by an external input received by the access management system; and calculating the overall risk score based on a combination of each determination.

Clause 19: The computer-implemented method according to any of Clauses 15-18, further comprising: prioritizing each user access request of the second set of requests based on at least one of the criticality level or a process history associated with each user access request, wherein processing each user access request of the second set of requests by an access management system based on an external input received by the access management system is further based on the prioritization of each user access request.

Clause 20: The computer-implemented method according to any of Clauses 15-19, further comprising storing each user access request in a processing history repository based on each user access request being processed.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer-readable medium, such as RAM, ROM, a magnetic medium such as a hard-drive or a floppy disk, or an optical medium such as a CD-ROM. Any such computer-readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer-readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A system for managing a user access request, the system comprising:
an access criticality module to determine information associated with a user access request;
an access criticality evaluation computation engine to determine a risk score associated with the user access request based on the determined information and to assign a criticality level to the user access request based on the determined risk score;
an automation and prioritization integrator to determine, based on the assigned criticality level, automatic or manual processing of the user access request; and
an access management module to automatically or manually process the user access request based on a determination of the automation and prioritization integrator.

2. The system of claim 1, wherein the access criticality module further comprises:
an entitlement criticality model to determine information associated with an access type of the user access request;
a user criticality model determine information associated with an identity of the user access request; and
a dynamic criticality model to determine information associated with a combination of the access type and the identity of the user access request.

3. The system of claim 1, wherein the access criticality evaluation computation engine further comprises:
an entitlement risk scorer to determine a risk score associated with an access type of the user access request;
a user risk scorer to determine a risk score associated with an identity of the user access request; and
a dynamic risk scorer to determine a risk score associated with a combination of the access type and the identity of the user access request.

4. The system of claim 1, further comprising a repository and automation policy module comprising a repository and an automation policy.

5. The system of claim 4, wherein the repository stores a processing history for the user access request, and wherein the automation policy defines how the determination of the automation and prioritization integrator is to be made.

6. The system of claim 1, wherein the access management module is configured to generate a prioritization for the user access request based on the assigned criticality level and based on a determination that the user access request is to be manually processed.

7. The system of claim 6, wherein the generated prioritization comprises a visual indicator visible to a user access request reviewer, and wherein the visual indicator corresponds to the assigned criticality level.

8. A computer-implemented method for managing a user access request, the computer-implemented method comprising:
determining, based on an entitlement criticality model and entitlement metadata, an entitlement risk score of a user access request, wherein the entitlement risk score relates to a risk associated with an access type of the user access request;
determining, based on a user criticality model and user metadata, a user risk score of the user access request, wherein the user risk score relates to a risk associated with an identity of the user access request;
determining an overall risk score of the user access request based on a combination of the entitlement risk score and the user risk score;
assigning, based on the overall risk score, a criticality level to the user access request, wherein the criticality level is one of a first criticality level or a second criticality level that is greater than the first criticality level;
automatically processing, based on the first criticality level being assigned to the user access request, the user access request by an access management system; and
processing, based on the second criticality level being assigned to the user access request, the user access request by an access management system based on an external input received by the access management system.

9. The computer-implemented method of claim 8, wherein the determining the entitlement risk score comprises:
collecting data from at least one of a configuration management database, an identity and access management database, or a target application, wherein the data comprises at least one of entitlement data or application data;
sending the data to a rule engine to generate the entitlement metadata; and
calculating the entitlement risk score based on the entitlement metadata.

10. The computer-implemented method of claim 8, wherein the determining the user risk score comprises:
collecting data from a human resources system, wherein the data comprises at least one of a user type, a user hierarchy level, a user location, or a user length of service of a user associated with the user access request; and
calculating the user risk score based on the data.

11. The computer-implemented method of claim 8, wherein determining the overall risk score further comprises:
determining that the user access request is an outlier compared to a plurality of user access requests associated with a plurality of users of a peer group; or
determining that the user access request violates segregation of duty; or
determining that the user access request has been previously processed by an external input received by the access management system; and
calculating the overall risk score based on a combination of each determination.

12. The computer-implemented method of claim 8, further comprising:
determining an updated entitlement risk score of the user access request;
determining an updated user risk score of the user access request;
determining an updated overall risk score of the user access request based on a combination of the updated entitlement risk score and the updated user risk score;
assigning, based on the updated overall risk score, an updated criticality level to the user access request, wherein the updated criticality level is one of the first criticality level or the second criticality level;
generating a user access re-processing request based on the updated criticality level being different than the criticality level; and
maintaining user access based on the updated criticality level being identical to the criticality level.

13. The computer-implemented method of claim 12, further comprising:
automatically processing, based on the updated criticality level being the first criticality level and the criticality level being the second criticality level, the user access re-processing request by the access management system; and
processing, based on the updated criticality level being the second criticality level and the criticality level being the first criticality level, the user access re-processing request by the access management system based on an external input received by the access management system.

14. The computer-implemented method of claim 8, further comprising storing the user access request in a processing history repository based on the user access request being processed.

15. A computer-implemented method for managing a plurality of user access requests, the computer-implemented method comprising:
determining, based on an entitlement criticality model and entitlement metadata, an entitlement risk score for each user access request of a plurality of user access requests, wherein the entitlement risk score for each user access request relates to a risk associated with an access type of each user access request;
determining, based on a user criticality model and user metadata, a user risk score for each user access request, wherein the user risk score for each user access request relates to a risk associated with an identity of each user access request;
determining an overall risk score for each user access request based on a combination of the entitlement risk score and the user risk score associated with each user access request;
assigning, based on the overall risk score of each user access request, a criticality level to each user access request, wherein the criticality level is one of a first criticality level or a second criticality level that is greater than the first criticality level;
assigning each user access request to a first set of requests or a second set of requests, wherein the first set of requests comprises each user access request that was assigned the first criticality level, and wherein the second set of requests comprises each user access request that was assigned the second criticality level;
automatically processing each user access request of the first set of requests by an access management system; and
processing each user access request of the second set of requests by an access management system based on a plurality of external inputs received by the access management system.

16. The computer-implemented method of claim 15, wherein the determining the entitlement risk score for each user access request comprises:
collecting data from at least one of a configuration management database, an identity and access management database, or a target application, wherein the data comprises at least one of entitlement data or application data;
sending the data to a rule engine, wherein the rule engine generates the entitlement metadata; and
calculating the entitlement risk score based on the entitlement metadata.

17. The computer-implemented method of claim 15, wherein determining the user risk score for each user access request comprises:
collecting data from a human resources system, wherein the data comprises at least one of a user type, a user hierarchy level, a user location, or a user length of service of a user associated with each user access request; and
calculating the user risk score based on the data.

18. The computer-implemented method of claim 15, wherein determining the overall risk score for each user access request further comprises:
determining if each user access request is an outlier compared to a plurality of user access requests associated with a plurality of users of a peer group;
determining if each user access request violates segregation of duty;
determining if each user access request has been previously processed by an external input received by the access management system; and
calculating the overall risk score based on a combination of each determination.

19. The computer-implemented method of claim 15, further comprising:
prioritizing each user access request of the second set of requests based on at least one of the criticality level or a process history associated with each user access request,
wherein processing each user access request of the second set of requests by an access management system based on an external input received by the access management system is further based on the prioritization of each user access request.

20. The computer-implemented method of claim 15, further comprising storing each user access request in a processing history repository based on each user access request being processed.
